(19) United States
(12) Patent Application Publication
(10) Pub. No.: US 2026/0118954 A1
(43) Pub. Date: Apr. 30, 2026

(54) SYSTEMS AND METHODS FOR TRACKING USER WORKFLOWS WITHOUT SCREEN RECORDING

(71) Applicant: Dell Products L.P., Round Rock, TX (US)

(72) Inventors: HANNA YEHUDA, Acton, MA (US); MING QIAN, Allston, MA (US); HANNAH CLAIRE HYATT, Seattle, WA (US); JOANNE HUBBARD, Concord, MA (US)

(21) Appl. No.: 18/931,563

(22) Filed: Oct. 30, 2024

(51) Int. Cl. G06F 3/01

(52) U.S. Cl. CPC G06F 3/013

(57) ABSTRACT

Methods and systems for managing operation of a data processing system are disclosed. To manage operation of the data processing system, interactions between a user and user interface elements may be tracked during performance of various workflows in order to identify and seamlessly implement updates to operations of the data processing system. The interactions may be tracked based on inferring attention of the user using eye tracking data and/or user input and without relying on content displayed on the user interfaces of the data processing system. By doing so, modifications to improve and optimize the user interface may be implemented and thereby improving the likelihood of the data processing system providing desirable computer implemented services to the user.

### FIELD

Embodiments disclosed herein relate generally to managing a data processing system. More particularly, embodiments disclosed herein relate to systems and methods for managing operations of data processing systems.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a block diagram illustrating a system in accordance with an embodiment.

FIGS. 2A-2C show diagrams illustrating data flows in accordance with an embodiment.

FIG. 2D shows a diagram illustrating an example of a representation of interactions between a user and user interface elements presented to the user by the data processing system.

FIG. 3 shows a flow diagram illustrating a method of managing operation of a data processing system in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for managing (operation of) data processing systems. The data processing systems may provide computer implemented services to users of the data processing systems. The computer implemented services may include any quantity and type of such services. To provide the computer implemented services, data processing systems may include any number of hardware components (e.g., processors, memory modules, storage devices, communication device, etc.). The hardware components may support execution of any number and types of application (e.g., software components).

To provide the computer implemented services, user feedback may need to be obtained. For example, a user may need provide user input by interacting with the data processing system via a graphical user interface (e.g., screen, display, etc.). To facilitate the interaction (e.g., between the user and the data processing system), various user interface elements (e.g., dashboards, menus and other widgets) may need to be displayed to the user via the graphical user interface. By displaying the user interface elements, the user may activate various functions of software components by navigating the user interface elements (e.g., widget functions and other components using graphical user interfaces).

However, if the user is unable to navigate the graphical user interfaces in a manner required to activate the function of the software components (e.g., intended use of the software components) then the function may not be activated and therefore, computer implemented services may not be provided and/or provided in an effective manner. For example,

For example, the user may select certain widgets (e.g., shown on a display hosted by the data processing system) as part of performing a task (e.g., one of the functions of the software). If the user is unable to locate the widgets (e.g., due to poor design and/or presentation of the widgets) and/or if the selection of widgets necessary to complete the task is complicated, the user may be deterred from engaging in further interactions with the user interface, and therefore, decrease the likelihood of the completion of the task and the desired computer implemented services may not be provided.

In an embodiment, a method for managing operation of a data processing system is provided. The method may include: obtaining eye tracking data and user input for a user of the data processing system over a period of time; making, using the user input and/or the eye tracking data, an identification of an occurrence of a monitored workflow performed by the user; based on the identification and during a performance of the monitored workflow: inferring, based on the eye tracking data and/or the user input, attention of the user on user interface elements presented to the user by the data processing system, and generating, based on the inferred attention of the user, a representation of interactions between the user and the user interface elements that resulted in completion of the monitored workflow; updating operation of the data processing system using at least the representation of the interactions to obtain an updated data processing system; and providing computer implemented services using the updated data processing system.

Making the identification may include: comparing the eye tracking data and/or the user input to trigger conditions associated with monitored workflows to identify when any of the monitored workflows start.

A portion of the trigger conditions for one of the monitored workflows may include a first trigger condition which when met indicates initiation of the one of the monitored workflows and a second trigger condition which when met indicates completion of the one of the monitored workflows.

The monitored workflow may be a user orientated task having a defined start, a defined end, and that, when performed, results in a predetermined outcome, and the monitored workflow may be performed using different sets of actions between the defined start and the defined end.

Inferring the attention of the user may include: identifying, based on the eye tracking data, that a dwell of a gaze of the user on at least one of the user interface elements has exceeded a duration of time; and concluding that the attention of the user is focused on the at least one of the user interface elements for at least the duration of time.

Inferring the attention of the user may include: identifying, based on the user input, that the user has interacted with at least one of the user interface elements; and concluding that the attention of the user is focused on the at least one of the user interface elements for at least a duration of time during which the user interacted with the at least one of the user interface elements.

Inferring the attention of the user may include: identifying, based on the user input and/or the eye tracking data, user interface elements that the user has focused attention on for durations of time exceeding a threshold; and concluding that the attention of the user is separately focused on the user interface elements for corresponding durations of time.

Generating the representation of the interactions may include: for each a user interface element of the user interface elements: identifying, based at least on the inferred attention, an interaction of the user with the user interface element; generating, based on the user interface element, a first string; generating, based on the interaction, a second string; and adding, to the representation of the interactions, the first string and the second string.

Adding the first string and the second string may include: combining the first string and the second string to obtain a third string; and appending the third string to the representation of the interactions.

The representation of the interactions may include a plurality of strings corresponding to a temporal order in which the interactions occurred.

The first string may uniquely identify the user interface element.

The second string may uniquely identify the interaction.

The second string may identify an outcome of the interaction.

In an embodiment, a non-transitory media is provided that may include instructions that when executed by a processor cause the computer-implemented method to be performed.

In an embodiment, a data processing system is provided that may include the non-transitory media and a processor, and may perform the computer-implemented method when the computer instructions are executed by the processor.

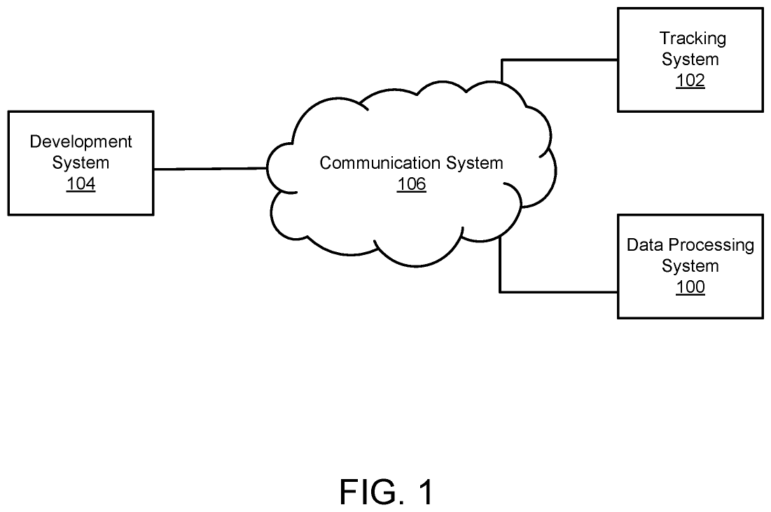

Turning to FIG. 1, a block diagram illustrating a system in accordance with an embodiment is shown. The system shown in FIG. 1 may provide computer-implemented services. The computer-implemented services may include data management services, data storage services, data access and control services, database services, and/or any other type of service that may be implemented with a computing device.

The system may include data processing system 100. Data processing system 100 may provide all, or a portion, of the computer implemented services. To provide the computer implemented services, workloads may be performed by various components of data processing system 100. To perform the workloads, user input may need to be obtained. The user input may include any type and quantity of information.

To obtain user input, a user may interact with a graphical user interface hosted by data processing system 100. For example, a user may perform physical actions such as, for example, pressing buttons on a keyboard, moving structures (e.g., such as a computer mouse), etc. To facilitate the interaction between a user and data processing system 100, various user interface elements may be presented to the user via the graphical user interface of data processing system 100. For example, the user interface elements may include menus, widgets, and/or other types of user interface elements shown on a display of data processing system 100.

A user may need to navigate the user interface elements (e.g., widgets, menus, etc.) and/or other elements presented on the graphical user interface of data processing system 100 in order to activate various functions of software components of the data processing system and thereby perform the desired workflow. However, if the user is unable to navigate the graphical user interfaces in a manner required to activate the function (e.g., of the software components), the function may not be activated and therefore, the computer implemented services may not be provided and/or provided in an efficient manner.

A user's interactions with the user interface elements (e.g., presented by data processing system 100) may be tracked in order to identify potential issues, challenges, and/or other hinderances that the user may experience when navigating the graphical user interface to complete various workflows. To do so, data processing system 100 may host hardware and/or software components that obtain signals and/or data representing eye gaze of a user (e.g., operating data processing system 100). For example, a camera lens hosted by data processing system 100 may record locations of where the user (e.g., while operating data processing system 100) is visually looking on the display of data processing system 100. The recorded locations of where the user was visually looking at may be represented by pixel range (e.g., range of pixels displayed by data processing system 100).

A video of the screen (e.g., information displayed to the user at the time of operation) may be recorded and used, in addition to the visual tracking data, to identify the user's interactions with the user interface elements. However, video recordings of information displayed to the user may present a problem regarding violation of privacy regulations and/or additional challenge to obtain authorization from the user to record the information prior to execution. For example, obtaining approval from the user's to record content displayed by data processing system 100 may present a challenge if the content includes sensitive data such as privileged and/or proprietary information and unauthorized disclosure of such data may be disadvantageous to the user.

Even if authorization to obtain a screen recording of the content displayed to a user was granted, the screen recording data may implicate privacy considerations and/or consume large quantities of storage space (e.g., of storage devices hosted by data processing system 100) as well as require a subject matter expert to review the screen recording data to identify potential challenges, issues, errors, etc. with the user interface elements in order to generate modifications to the operation of the data processing system 100 to improve usability of data processing system 100.

In general, embodiments disclosed herein may provide methods, systems, and/or devices for managing operation of a data processing system. To manage operation of the data processing system, a system in accordance with an embodiment may track interactions between a user (of the data processing system) and user interface elements (presented to the user by the data processing system) during performance of various workflows in order to identify and seamlessly implement updates to operations of the data processing system based on the tracked interactions that resulted in completion of the workflows. The system may generate a representation of the interactions between the user and user interface elements (for a workflow) may be based on inferred attention of the user on the user interface elements. For example, the system may interpret how the user navigates and interacts with the user interface elements by analyzing eye tracking data and user input during performance of the workflow.

By doing so, representation of the interactions between the user and the user interface elements may be generated without utilizing explicit information displayed on a display of the data processing system and may be leveraged to update and optimize the user interface (e.g., design of the user interface, user interface elements, etc.), thereby streamlining workflows, improving the likelihood of a user's experience (e.g., operating the data processing system), and/or increasing the likelihood of the data processing system providing desirable computer implemented services to the user.

To provide the above noted functionality, the system of FIG. 1 may include data processing system 100, tracking system 102, development system 104, and communication system 106. Data processing system 100, tracking system 102, development system 104, and/or any other type of devices not shown in FIG. 1 may perform all, or a portion of the computer-implemented services independently and/or cooperatively. Each of these components is discussed below.

Data processing system 100 may (i) facilitate collection of data, (ii) identify the type of data collected, (iii) provide the data to external entities (e.g., tracking system 102, development system 104, etc.), (iv) receive information including instructions for updating operation of the data processing system, and/or (v) otherwise facilitate collection, transmission, and/or management of data regarding interactions between user interface elements and a user (operating data processing system 100).

Data processing system 100 may include hardware components usable to provide the computer implemented services. For example, data processing system 100 may be implemented using a computing device such as a laptop computer, desktop computer, portable computer, and/or other types of computing devices. Data processing system 100 may include devices which may collect, store, and/or manage data, various types of sensors connected to a computer that collects information (e.g., camera, microphone, etc.), and/or any other type of data collection devices.

Data processing system 100 may host software that may use user input to provide the computer implemented services. For example, the software may provide user input fields and/or other elements through which the user may provide information to manage and/or use the computer implemented services provided by data processing system 100. For example, the user may physically interact with data processing system 100 (and/or component thereof), thereby allowing signals and/or data to include information regarding the physical actions of the user.

For example, if a user actuates a moveable structure (e.g., buttons) of a human interface device (of data processing system 100), data processing system 100 may track the actuation of the button and provide signals and/or data reflecting the actuation (e.g., the user input).

To provide computer implemented services, tracking system 102 may (i) obtain predefined parameters for various workflows to monitor (for data processing system 100), (ii) obtain data (eye tracking data, user input, etc.) from data processing system 100, (iii) identify occurrences of a monitored workflow performed by the user of data processing system 100, (iv) based on the identification and during performance of the monitored workflow, infer the attention of the user on user interface elements (presented to the user by data processing system 100) based on the eye tracking data and/or user input, (v) generate, based on the inferred attention of the user, a representation of the interactions between the user and the user interface elements that resulted in completion of the monitored workflow, (vi) provide the representation of the interactions to development system 104, and/or (vii) otherwise facilitate collection, transmission, and/or analysis of data usable for tracking the interactions between a user and user interface elements (of data processing system 100).

Development system 104 may include any number and/or type of device (e.g., data processing system, management systems, storage devices, user devices, etc.) that may provide computer implemented services, such as development services. To perform its functionality, development system 104 may (i) obtain data (e.g., eye tracking data, user input, representation of interactions between a user and user interface elements) from tracking system 102, (ii) manage and/or provide access to the data (e.g., to an authorized subject matter expert), (iii) provide updates (e.g., for the user interfaces) for operation of data processing system 100, and/or (iv) otherwise participate in managing operation of data processing system 100.

Thus, the operation of data processing system 100 may be managed according to interactions between a user and user interface elements (presented by data processing system 100) resulting in completion of a workflow. The interactions may be based on inferred attention of the user using eye tracking data and user input during performance of the workflow. The tracked interactions for various workflows may be utilized to update and optimize the user interface (and/or user interface elements) to reduce unnecessary, repetitive steps (e.g., performed by the user) to complete the workflows. By doing so, a system in accordance with embodiment disclosed herein may provide data processing systems having, for example, (i) improved user experiences by minimizing unnecessary steps and/or slowdowns in completion of a workflow, and/or (ii) improved computing resource availability for desired computer implemented services.

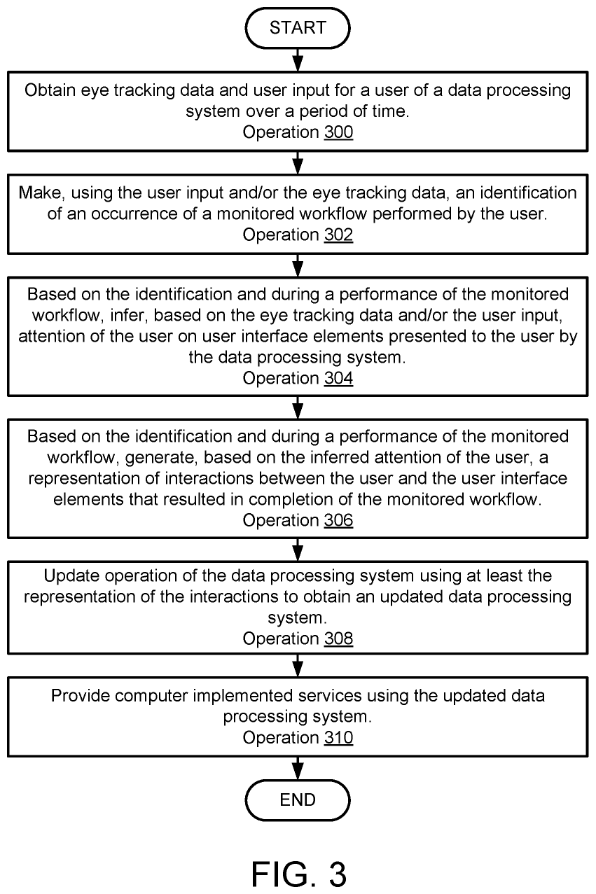

When providing its functionality, data processing system 100, tracking system 102, and/or development system 104 may perform all, or a portion, of the method and/or actions shown in FIG. 3.

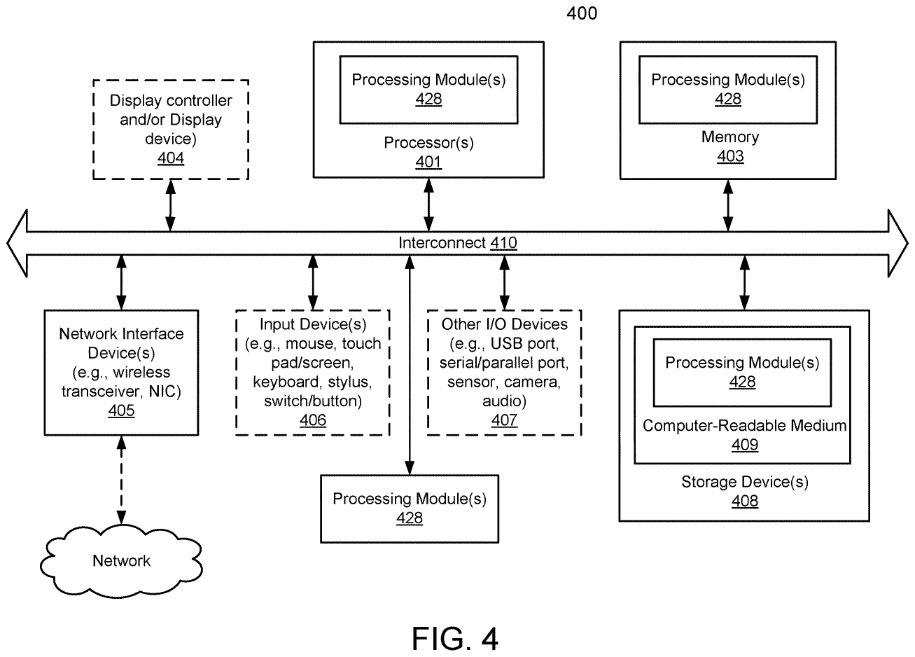

Any of (and/or components thereof) data processing system 100, tracking system 102, and/or development system 104 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to FIG. 4.

Any of the components illustrated in FIG. 1 may be operably connected to each other (and/or components not illustrated) with communication system 106. In an embodiment, communication system 106 includes one or more networks that facilitate communication between any number of components. The networks may include wired networks and/or wireless networks (e.g., and/or the Internet). The networks may operate in accordance with any number and types of communication protocols (e.g., such as the internet protocol).

While illustrated in FIG. 1 as including a limited number of specific components, a system in accordance with an embodiment may include fewer, additional, and/or different components than those illustrated therein.

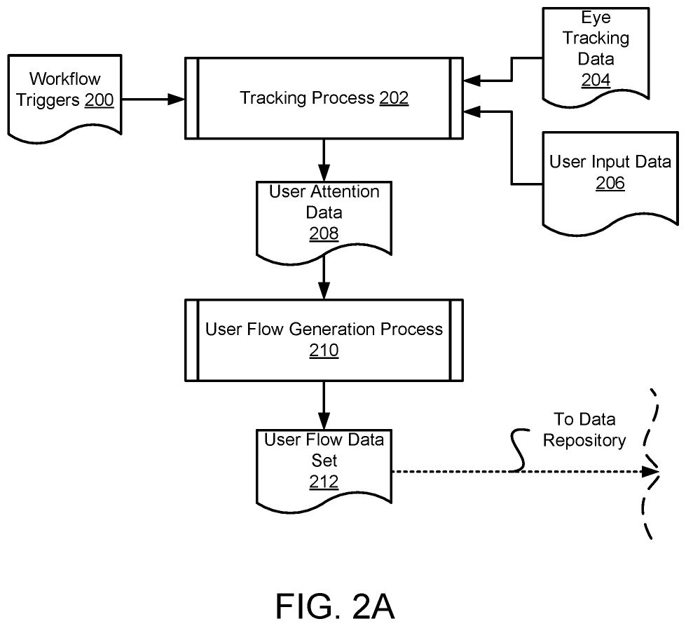

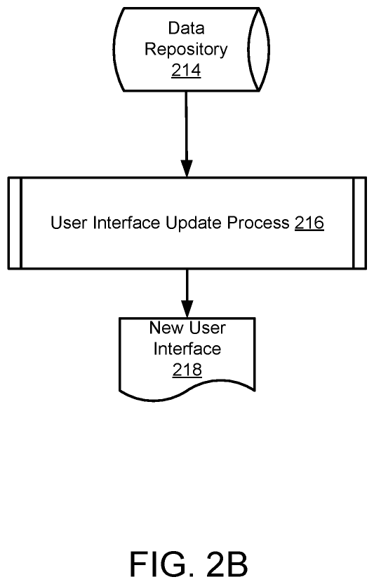

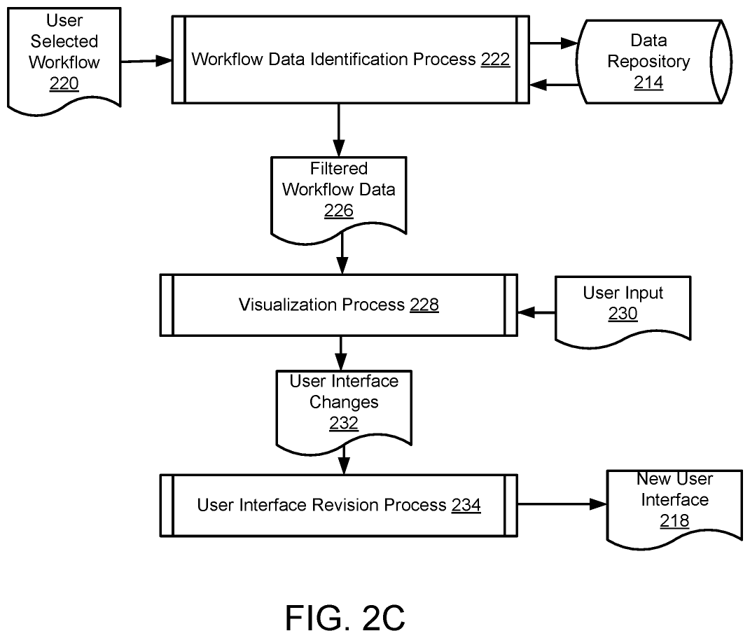

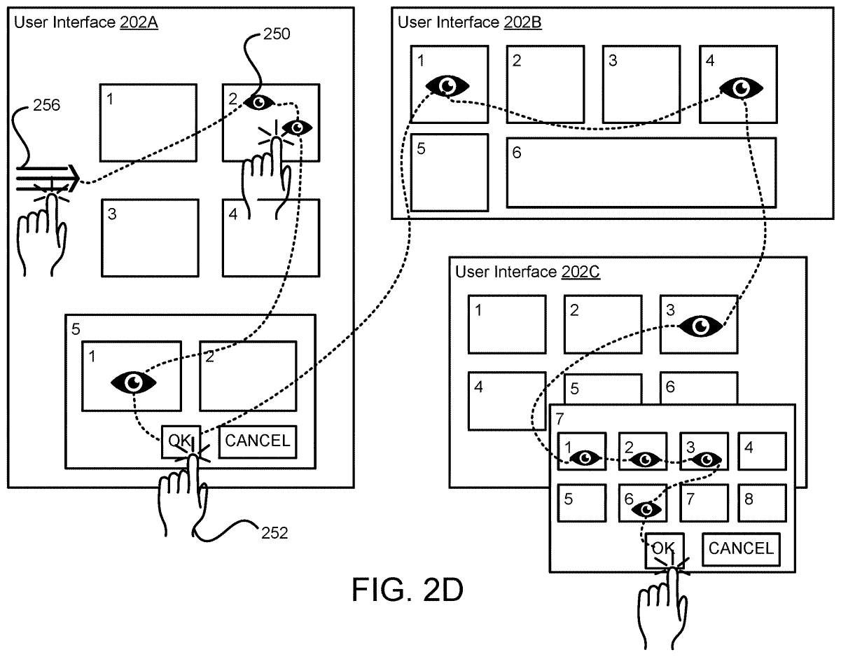

To further clarify embodiments disclosed herein, diagrams illustrating data flows implemented by a system over time in accordance with an embodiment are shown in FIGS. 2A-2C. In FIGS. 2A-2C, a first set of shapes (e.g., 204, 208) is used to represent data structures, and a second set of shapes (e.g., 202, 210) is used to represent processes performed using data, and a third set of shapes (e.g., 214) is used to represent large scale data structures such as databases.

Turning to FIG. 2A, a first data flow diagram illustrating data flows, data processing, and/or other operations that may be performed by the system of FIG. 1 in accordance with an embodiment is shown. The first data flow diagram may illustrate data used in and data processing performed in generating a representation of interactions between a user and user interface elements of a data processing system.

To generate a representation of the interactions between a user and user interface elements, eye tracking data 204 and user input data 206 may be obtained over a period of time (e.g., from data processing system 100). Eye tracking data 204 may include any type and/or quantity of data relating to a user's eye gaze on user interface elements (e.g., presented by the data processing system 100). For example, eye tracking data 204 may include information about where the user's gaze is focused on the screen (e.g., of data processing system 100).

User input data 206 may include any type of data representing physical actions such as, for example, pressing buttons, moving structures, etc. The physical actions of the user (e.g., operating data processing system 100) may be sensed by various devices and the sensing may be interpreted (e.g., translated) into the user input (e.g., user input data). For example, user input data 206 may include a user operating a keyboard, a mouse, and/or any other auxiliary device capable of receiving input signals from the user.

Tracking process 202 may collect and analyze eye tracking data 204 and user input data 206 during performance of various monitored workflows. Each monitored workflow (e.g., performed by a user of data processing system 100) may represent a user orientated task that has a defined start, a defined end, and that, when performed, results in a predetermined outcome.

To initiate tracking process 202, workflow triggers 200 may be identified. Workflow triggers 200 may include predefined parameters for monitored workflows, and may include trigger conditions for each monitored workflow indicating initiation and/or completion of the respective monitored workflow.

User input data 206 and/or eye tracking data 204 may be compared to workflow triggers 200 (trigger conditions associated with monitored workflows) to identify when any of the monitored workflows start. For example, a trigger condition for a monitored workflow may include identifying an instance of input signals received from selecting a widget (e.g., menu icon) via operation of a graphical user interface by a user. By identifying the selection of the widget (e.g., workflow trigger), the monitored workflow associated with the selection of the widget may be identified and thereby, initiate tracking process 202.

Once the occurrence of the monitored workflow has been identified, tracking process 202 may be performed to obtain user attention data 208 during performance of the monitored workflow. The attention of the user may be inferred based on eye tracking data 204, and/or user input 206. Tracking process 202 may include collecting and/or analyzing eye tracking data 204 and user input data 206 during performance of the monitored workflow.

Eye tracking data 204 may be used to identify that a dwell of a gaze of the user on at least one of the user interface elements has exceeded a duration of time (e.g., predefined period of time set by a subject matter expert) and conclude that the attention of the user is focused on at least one of the user interface elements for the duration of time.

User input data 206 may be used to identify that the user has interacted with at least one of the user interface elements and conclude that the attention of the user is focused on the user interface elements for the duration of time (e.g., during which the user interacted with the user interface elements).

User attention data 208 may include any type and quantity of data representing inferred attention of the user, and may include a description of the user interface element for the interaction. For example, the user's attention on user interface elements (e.g., screens, view-blocks presented on different screens, etc.) may be inferred based on location of the user's eye gaze (e.g., from eye tracking data 204) and/or interactions of the user with the user interface elements (e.g., from user input data 206).

User attention data 208 for each monitored workflow may be obtained until the trigger condition indicating completion of the respective monitored workflow has been met. For example, for a monitored workflow, the trigger condition indicating completion of the monitored workflow may include terminating operation of a program, and if user input data 206 indicates selection of a closing out the program (e.g., via left click of a button on a computer mouse by a user) displayed via the graphical user interface, the trigger condition may be met and thereby conclude obtaining user attention data (208) for the monitored workflow.

User attention data 208 may be used in performing user flow generation process 210 to generate a representation of the interactions. During user flow generation process 210, the inferred attention of the user and interaction data may be processed to generate a user flow data set (e.g., user flow data set 212). A first string of data representing the user interface element and a second string of data representing the interaction (e.g., based on the inferred attention of the user during performance of the monitored workflow) may be concatenated into a third string (or a single data structure) representing a temporal order in which the interactions occurred.

To do so, for each user interface element (e.g., identified via user attention data 208), an interaction of the user with the user interface element may be identified and for each identified interaction, a label indicating the outcome of the interaction may be generated. For example, user input data 206 may be analyzed to append the status of the interaction (e.g., success or failure) between the user and the user interface element.

If the interaction between the user and the user interface element (e.g., program presented to the user via the graphical user interface) is accepted (e.g., a click on a button where the program accepts the user input and activates the next activity in the workflow), the interaction may be identified as a success. Conversely, if the interaction between the user and the user interface element is rejected (e.g., a click on the button where the program denies the user input and does not activate the next activity in the workflow), the interaction may be identified as a failure.

The interactions between the user and the user interface elements may provide data necessary to identify failures that occur around attempts to perform workflows. The interactions that are indicated as failures may provide guidance for eliminating and/or reducing the likelihood of potential failures to occur in the future.

The generated user flow data representing the interactions between the user and the user interface elements that resulted in completion of the monitored workflow is stored in a dataset (e.g., user flow data set 212). User flow data set 212 may be provided to any type of data repository for storage (e.g., accessible by tracking system 102, development system 104, etc.).

Thus, as shown in the example of FIG. 2A, a system in accordance with an embodiment may facilitate collection of tracking data (e.g., eye tracking data and user input) for a user interacting with user interface elements over a period of time, identifies user flows during the monitored workflows, and generates a representation of the user's interactions to further improve operation of the data processing system.

Turning to FIG. 2B, a second data flow diagram illustrating data flows, data processing, and/or other operations that may be performed by the system of FIG. 1 in accordance with an embodiment is shown. The second data flow diagram may illustrate data used in and data processing performed in utilizing data in preparation of obtaining a new user interface.

To utilize data in preparation of obtaining the new user interface, user flow data set 212 may be obtained and used in performance of various updating processes. User flow data set 212 may be stored in data repository 214 and accessible, for example, by development system 104. User flow data set 212 may include different types of user flow data sets obtained at different points in time by a tracking system (e.g., 102 shown in FIG. 1).

Based on a selected monitored workflow (e.g., by a user and/or administrator of data processing system 100), the associated user flow data set 212 may be obtained from data repository 214. The user flow data set for each performance of the selected monitored workflow may be utilized during performance of user interface update process 216 to determine modifications to the user interface to improve user experience and workflow efficiency. Refer to FIG. 2C for additional details regarding analyzation of user flow data and implementation of revisions to user interfaces.

As a result of performing user interface update process 216, a new user interface 218 may be obtained. New user interface 218 may include an updated user interface incorporating modifications and/or improvements to update operation data processing system 100 (e.g., as provided during user interface update process 216).

Turning to FIG. 2C, a third data flow diagram illustrating data flows, data processing, and/or other operations that may be performed by the system of FIG. 1 in accordance with an embodiment is shown. The third data flow diagram may illustrate data used in and data processing performed in generating a visual representation of user interactions to update the user interface.

To generate the visual representation of user interactions, user selected workflow 220 may be obtained. User selected workflow 220 may include any type and quantity of monitored workflows, and may include a description of user orientated task. User selected workflow 220 may be obtained from a user operating development system 104 (e.g., user experience designer and/or subject matter expert). For example, a developer (e.g., via operation of development system 104) may identify a monitored workflow they are focused on improving and/or analyzing.

Based on the selected workflow, workflow data identification process 222 may be performed. During workflow data identification process 222, the selected workflow may be used in querying data repository 214 to obtain relevant data related to the selected workflow. For example, an identifier for the selected workflow may be used to perform a look up to identify user flow data sets associated with the selected workflow.

As a result of performing workflow data identification process 222, filtered workflow data 226 may be obtained. Filtered workflow data 226 may include any filtered data retrieved from data repository 214 to include relevant information about the selected workflow. Filtered workflow data 226 may include each recorded user flow data set for the selected workflow. Filtered workflow data 226 may be used in visualization process 228 to generate a visual representation of the interactions between the user and user interface elements during performance of each workflow.

Visualization process 228 may include generating a visual representation of the user's interactions with each workflow performed. The visual representation may be presented, for example, to a developer (via operation of development system 104) to illustrate how users are interacting with user interface elements to complete various workflows.

As part visualization process 228, user input 230 may be obtained, for example, by the developer and/or subject matter expert (e.g., operating development system 104 and/or graphical user interface hosted by development system 104). User input 230 may include any recommendations or suggestions for modifications to the user interface based on the visual representation of the interactions during performance of the workflows. For example, user input 230 may include input on potential changes to the user interface based on informed insights impacting the current user interface design, such as identified bottlenecks or inefficiencies.

For example, the developer may identify that users are struggling to find and click on a specific button (e.g., the “submit” button is too small and buried at the bottom of a form) within a web application, which is essential for completing the selected workflow. User input 230 may include a recommendation to increase the size of the “submit” button, move the “submit” button to the top of the form, and/or any other modifications that may improve the user's ability to easily see the “submit”button.

User interface changes 232 may include instructions for modifications to the user interface. For example, user interface changes 232 may identify font size adjustments, widget reorganization, and/or any other modifications based at least in part on user input 230.

User interface revision process 234 may include implementing the user interface changes 232 to the user interface in order to obtain new user interface 218. For example, modifications to the user interface may be implemented within the application code associated with the respective programs. For example, implementation of the modifications may be performed by moving and/or resizing the “submit”button.

New user interface 218 may be obtained as a result of performing user interface revision process 234. New user interface 218 may be an updated user interface that provides an improved user interaction and user workflows, and overall efficiency and user experience.

Turning to FIG. 2D, an example illustration of interactions between a user and user interface elements (presented by a data processing system) during performance of a monitored workflow.

In FIG. 2D, various symbols (e.g., 250, 252, 256, etc.) are used to indicate interactions with a user interface by a user. For example, the symbols may include a first illustrative symbol 252, which represents using a pointing device to click on a graphical user interface element. For example, a user may operate a computer mouse to navigate the pointing device (e.g., cursor) displayed on the user interface element and provide user input (e.g., user input data 206 shown in FIG. 2A).

As an additional example, a second illustrative symbol 250 may indicate a user's gaze has been directed at a portion of the user interface for a duration of time (e.g., exceeding a threshold) that we conclude that the user's attention is directed to that user interface element. In addition, a third illustrative symbol 256 may represent a menu icon (widget displayed on user interface 202A).

As described above, to identify when any of monitored workflows start, eye tracking data and/or user input may be compared to trigger conditions associated with monitored workflows. The user may select the menu icon (e.g., trigger condition) to initiate a monitored workflow. The monitored workflow may include navigating a first program (e.g., user interface 202A) by visually reviewing user interface element two and two point one, activating function of user interface element two (e.g., via user input), visually reviewing user interface element one of sub menu five, and selecting the “OK”button (e.g., indicated by click).

The monitored workflow may continue with operation of a second program (e.g., user interface 202B), by visually reviewing user interface element one and four (e.g., illustrated by second illustrative symbol) of user interface 202B. After which, the user may continue the monitored workflow via operation of a third program (e.g., user interface 202C) by visually reviewing user interface element three of user interface 202C, user interface element one, two, three, and six of sub menu seven, and selecting “OK”to complete the monitored workflow.

By generating a logical attention map during performance of a workflow using eye tracking data and user input, the attention of the user may be inferred. The inferred attention of the user may be used to identify an interaction of the user with the user interface elements and generate a first string representing the user interface element and a second string representing the interaction. The second string may uniquely identify the interaction and/or an outcome of the interaction. The first string and the second string may be concatenated (e.g., combined) to obtain a third string representing the interactions of the user with the user interface elements corresponding to a temporal order in which the interactions occurred.

The representation of interactions between the user and the user interface elements may be used to update operation of data processing system 100. For example, a user experience designer may use the information to reconfigure the design of an application. The improvements in downstream use (e.g., usability) may allow for improved remediation of future failures of data processing systems, thereby improving the reliability and/or accessibility to computer-implemented services provided by the data processing systems.

As discussed above, the components of FIGS. 1-2D may perform various methods to improve user experiences by updating operations of data processing systems using eye tracking data and user input. By using eye tracking data and user input during performance of a workflow, attention of the user may be inferred and a representation of the interactions between the user and user interface elements may be generated without obtaining content displayed by the user interface elements (and/or graphical user interfaces) presented by the data processing system.

FIG. 3 illustrates a method that may be performed by the components of the system of FIGS. 1-2D. In the diagram discussed below and shown in FIG. 3, any of the operations may be repeated, performed in different orders, and/or performed in parallel with or in a partially overlapping in a timely manner with other operations. The method described with respect to FIG. 3 may be performed by a data processing system and/or another device.

Turning to FIG. 3, a flow diagram illustrating a method of managing a data processing system in accordance with an embodiment is shown. The method may be performed, for example, by a data processing system, a management system, a communication system, hardware resources, and/or other components illustrated in FIGS. 1-2D.

At operation 300, eye tracking data and user input for a user of a data processing system may be obtained over a period of time. The eye tracking data and user input may be obtained via (i) generating the eye tracking data and user input, (ii) receiving the eye tracking data and user input from an external device, and/or (iii) by any other methods. Generating the eye tracking data and user input may include: obtaining, by hardware and/or software components of the data processing system, eye gaze of a user operating the data processing system, obtaining, by the hardware and/or software components of the data processing system, and/or by performing any other methods. For example, obtaining the user input may include monitoring input signals received from the user via operation of various auxiliary devices (e.g., mouse, keyboard, etc.).

At operation 302, an identification of an occurrence of a monitored workflow performed by the user may be made. The identification may be made using the user input and/or the eye tracking data. Making the identification may include comparing the eye tracking data and/or the user input to trigger conditions associated with monitored workflows to identify when any of the monitored workflows start.

At operation 304, based on the identification and during a performance of the monitored workflow, attention of the user on user interface elements presented to the user by the data processing system may be inferred. Inferring the attention of the user may be facilitated by performing various, different methods.

Inferring the attention of the user may include: identifying, based on the eye tracking data, that a dwell of a gaze of the user on at least one of the user interface elements has exceeded a duration of time; and concluding that the attention of the user is focused on the at least one of the user interface elements for at least the duration of time.

Inferring the attention of the user may include: identifying, based on the user input, that the user has interacted with at least one of the user interface elements; and concluding that the attention of the user is focused on the at least one of the user interface elements for at least a duration of time during which the user interacted with the at least one of the user interface elements.

Inferring the attention of the user may include: identifying, based on the user input and/or the eye tracking data, user interface elements that the user has focused attention on for durations of time exceeding a threshold; and concluding that the attention of the user is separately focused on the user interface elements for corresponding durations of time.

At operation 306, based on the identification and during the performance of the monitored workflow, a representation of interactions between the user and the user interface elements that results in completion of the monitored workflow may be generated. The representation of interactions may be generated based on the inferred attention of the user. Generating the representation of the interactions may include: for each user interface element of the user interface elements: (i) identifying, based at least on the inferred attention, an interaction of the user with the user interface element, (ii) generating, based on the user interface element, a first string, (iii) generating, based on the interaction, a second string, and/or (iv) adding, to the representation of the interactions, the first string and the second string.

Adding the first string and the second string may include (i) combining the first string and the second string to obtain a third string, and/or (ii) appending the third string to the representation of the interactions.

At operation 308, operation of the data processing system may be updated using at least the representation of the interactions to obtain an updated data processing system. Operation of the data processing system may be updated by (i) ingesting the at least the representation of the interactions by the data processing system, (ii) modifying operation based on the ingested representation of the interactions, and/or (iii) by performing any other methods.

Operation of the data processing system may be updated by (i) providing the at least the representation of the interactions to a management system (e.g., operated by a user experience designer or another subject matter expert), (ii) receiving instructions for modifying operation of the data processing system from the management system, and/or (iii) by performing any other methods. For example, the representation of the interactions may be provided via a message to development system 104 (e.g., shown in FIG. 1) to provide to a subject matter expert with input data to generate recommended modifications to operation of the data processing system.

At operation 310, computer implemented services may be provided using the updated data processing system. The computer implemented services may be provided by (i) ingesting, by the updated data processing system, at least the representation of the interactions, (ii) performing the computer implemented services by the updated data processing system, and/or (iii) performing any other methods.

The method may end following operation 310.

Using the methods illustrated in FIG. 3, embodiments disclosed herein may provide systems and methods usable to manage operations of data processing systems by implementing control policies corresponding to different occurrences of policy management events using out-of-band methods. By implementing control policies, a desired state for a discrete graphics component may be identified and operation of the discrete graphics component may be updated based on the desired state. By updating operation of the discrete graphics component, computer implemented services that confirm to the limits specified by the control policies may be provided.

Any of the components illustrated in FIGS. 1-3 may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system. Note also that system 400 is intended to show a high level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein.

Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401 may communicate with memory 403, which in one embodiment can be implemented via multiple memory devices to provide for a given amount of system memory. Memory 403 may include one or more volatile storage (or memory) devices such as random access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as a SSD cache to enable non-volatile storage of context state and other such information during power down events so that a fast power up can occur on re-initiation of system activities. Also a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for managing operation of a data processing system, the method comprising:
obtaining eye tracking data and user input for a user of the data processing system over a period of time;
making, using the user input and/or the eye tracking data, an identification of an occurrence of a monitored workflow performed by the user;
based on the identification and during a performance of the monitored workflow:
inferring, based on the eye tracking data and/or the user input, attention of the user on user interface elements presented to the user by the data processing system, and
generating, based on the inferred attention of the user, a representation of interactions between the user and the user interface elements that resulted in completion of the monitored workflow;
updating operation of the data processing system using at least the representation of the interactions to obtain an updated data processing system; and
providing computer implemented services using the updated data processing system.

2. The method of claim 1, wherein making the identification comprises:
comparing the eye tracking data and/or the user input to trigger conditions associated with monitored workflows to identify when any of the monitored workflows start.

3. The method of claim 2, wherein a portion of the trigger conditions for one of the monitored workflows comprising a first trigger condition which when met indicates initiation of the one of the monitored workflows and a second trigger condition which when met indicates completion of the one of the monitored workflows.

4. The method of claim 1, wherein the monitored workflow is a user orientated task having a defined start, a defined end, and that, when performed, results in a predetermined outcome, and the monitored workflow may be performed using different sets of actions between the defined start and the defined end.

5. The method of claim 1, wherein inferring the attention of the user comprises:
identifying, based on the eye tracking data, that a dwell of a gaze of the user on at least one of the user interface elements has exceeded a duration of time; and
concluding that the attention of the user is focused on the at least one of the user interface elements for at least the duration of time.

6. The method of claim 1, wherein inferring the attention of the user comprises:
identifying, based on the user input, that the user has interacted with at least one of the user interface elements; and
concluding that the attention of the user is focused on the at least one of the user interface elements for at least a duration of time during which the user interacted with the at least one of the user interface elements.

7. The method of claim 1, wherein inferring the attention of the user comprises:
identifying, based on the user input and/or the eye tracking data, user interface elements that the user has focused attention on for durations of time exceeding a threshold; and
concluding that the attention of the user is separately focused on the user interface elements for corresponding durations of time.

8. The method of claim 1, wherein generating the representation of the interactions comprises:
for each a user interface element of the user interface elements:
identifying, based at least on the inferred attention, an interaction of the user with the user interface element;
generating, based on the user interface element, a first string;
generating, based on the interaction, a second string; and
adding, to the representation of the interactions, the first string and the second string.

9. The method of claim 8, wherein adding the first string and the second string comprises:
combining the first string and the second string to obtain a third string; and
appending the third string to the representation of the interactions.

10. The method of claim 9, wherein the representation of the interactions comprises a plurality of strings corresponding to a temporal order in which the interactions occurred.

11. The method of claim 8, wherein the first string uniquely identifies the user interface element.

12. The method of claim 11, wherein the second string uniquely identifies the interaction.

13. The method of claim 11, wherein the second string identifies an outcome of the interaction.

14. A non-transitory machine-readable medium having instructions stored therein, which when executed by a processor, cause the processor to perform operations for managing operation of a data processing system, the operations comprising:
obtaining eye tracking data and user input for a user of the data processing system over a period of time;
making, using the user input and/or the eye tracking data, an identification of an occurrence of a monitored workflow performed by the user;
based on the identification and during a performance of the monitored workflow:
inferring, based on the eye tracking data and/or the user input, attention of the user on user interface elements presented to the user by the data processing system, and
generating, based on the inferred attention of the user, a representation of interactions between the user and the user interface elements that resulted in completion of the monitored workflow;
updating operation of the data processing system using at least the representation of the interactions to obtain an updated data processing system; and
providing computer implemented services using the updated data processing system.

15. The non-transitory machine-readable medium of claim 14, wherein making the identification comprises:
comparing the eye tracking data and/or the user input to trigger conditions associated with monitored workflows to identify when any of the monitored workflows start.

16. The non-transitory machine-readable medium of claim 15, wherein a portion of the trigger conditions for one of the monitored workflows comprising a first trigger condition which when met indicates initiation of the one of the monitored workflows and a second trigger condition which when met indicates completion of the one of the monitored workflows.

17. The non-transitory machine-readable medium of claim 14, wherein the monitored workflow is a user orientated task having a defined start, a defined end, and that, when performed, results in a predetermined outcome, and the monitored workflow may be performed using different sets of actions between the defined start and the defined end.

18. A data processing system, comprising:
a processor; and
a memory coupled to the processor to store instructions, which when executed by the processor, cause the processor to perform operations for managing operation of the data processing system, the operations comprising:
obtaining eye tracking data and user input for a user of the data processing system over a period of time;
making, using the user input and/or the eye tracking data, an identification of an occurrence of a monitored workflow performed by the user;
based on the identification and during a performance of the monitored workflow:
inferring, based on the eye tracking data and/or the user input, attention of the user on user interface elements presented to the user by the data processing system, and
generating, based on the inferred attention of the user, a representation of interactions between the user and the user interface elements that resulted in completion of the monitored workflow;
updating operation of the data processing system using at least the representation of the interactions to obtain an updated data processing system; and
providing computer implemented services using the updated data processing system.

19. The data processing system of claim 18, wherein making the identification comprises:
comparing the eye tracking data and/or the user input to trigger conditions associated with monitored workflows to identify when any of the monitored workflows start.

20. The data processing system of claim 19, wherein a portion of the trigger conditions for one of the monitored workflows comprising a first trigger condition which when met indicates initiation of the one of the monitored workflows and a second trigger condition which when met indicates completion of the one of the monitored workflows.
